(19) United States
(12) Patent Application Publication
(10) Pub. No.: US 2026/0077433 A1
(43) Pub. Date: Mar. 19, 2026

(54) Apparatus and Methods for Water-Assisted Singulation

(71) Applicant: Intel Corporation, Santa Clara, CA (US)

(72) Inventors: Praveen SREERAMAGIRI, Gilbert, AZ (US); Robin McREE, Chandler, AZ (US); Jesse JONES, Chandler, AZ (US); Gang DUAN, Chandler, AZ (US); Yi LI, Chandler, AZ (US); Ibrahim EL KHATIB, Chandler, AZ (US); Srinivas PIETAMBARAM, Chandler, AZ (US); Kari HERNANDEZ, Phoenix, AZ (US); Soham AGARWAL, Chandler, AZ (US); Benjamin DUONG, Phoenix, AZ (US); Pratyush MISHRA, Tempe, AZ (US); Pratyasha MOHAPATRA, Tempe, AZ (US)

(21) Appl. No.: 18/884,193

(22) Filed: Sep. 13, 2024

(51) Int. Cl. B23K 26/364; B23K 26/00; B23K 26/14; B23K 26/146; B23K 26/70; B23K 103/00

(52) U.S. Cl. CPC B23K 26/364; B23K 26/0093; B23K 26/146; B23K 26/1462; B23K 26/702; B23K 2103/54

(57) ABSTRACT

According to the various aspects, a present tool assembly or apparatus includes a water delivery component configured to direct water to a workpiece, and a cutting component for removing material to form cut-streets for die singulation. The present tool assembly is configured to operate to remove build-up layers and other layers from a glass core of the workpiece in a wet environment and a dry environment, at cut-street locations, and perform methods for dicing the workpiece.

### BACKGROUND

As semiconductor technology advances, the need to improve performance and lower costs for integrated circuit design and fabrication are constant challenges. It is becoming more difficult and costly to realize high-volume manufacturing for semiconductors as transistors continue to shrink in size. Cost savings may be potentially realized by building more efficient structures and using materials that improve power performance and yields.

Presently, glass is a commonly used substrate or core for manufacturing semiconductors. It is a low-cost material with excellent properties, such as high thermal resistance, chemical resistance, high flatness, low coefficient of thermal expansion, etc. In addition, glass substrates have high smoothness and shape stability that may contribute to the prevention of yield degradation due to defects arising from various processing steps. However, glass is an amorphous material and cannot be easily etched anisotropically and/or separated into dies.

In a back-end package process, dicing is performed to divide wafers and panels into individual chips. Such individualization of a wafer or panel to multiple chips is called “singulation”, and a process of sawing a wafer plate or panel into a single cuboid is called “die sawing”. For the dicing and singulation of glass substrates, the use of a mechanical separator (e.g., cutting glass substrate with hard metal/diamond spinning blades) has traditionally been the predominant methodology, and laser cutting (e.g., using a laser beam to heat a localized area of the glass that can be cooled rapidly to induce thermal stress and create a controlled crack) has recently been used as an emerging methodology. These methods may encounter significant challenges when applied in isolation under stringent cutting conditions, especially as the height of the substrate layer stack increases with build-up (BU) layers, interconnects, devices, and other features formed on the glass substrate.

For such conditions, the stress induced by cutting may lead to glass delamination, defects propagating through the glass core resulting in “SeWaRe” (i.e., glass core splitting), breakage, and other compatibility challenges. The use of dicing and singulation processes that allow glass substrates/cores and the build-up layers thereon to be easily separated, which also provide reduced mechanical stress and thermally-induced stress, may provide lower costs and improve yields.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. The dimensions of the various features or elements may be arbitrarily expanded or reduced for clarity. In the following description, various aspects of the present disclosure are described with reference to the following drawings, in which:

FIG. 1 shows exemplary representations of a tool assembly/apparatus according to an aspect of the present disclosure;

FIGS. 2A through 2C show exemplary representations of a workpiece at various stages of processing according to aspects of the present disclosure;

FIGS. 3 and 3A show exemplary representations of a laser beam directed by a water jet according to an aspect of the present disclosure;

FIG. 4 shows an exemplary representation of laser ablation of a workpiece according to an aspect of the present disclosure;

FIG. 5 shows an exemplary representation of a workpiece being diced along a cut-street according to an aspect of the present disclosure;

FIG. 6 shows a simplified flow diagram for an exemplary method according to an aspect of the present disclosure;

FIG. 7 shows an exemplary representation of a laser operation using a laser beam and flowing water directed to a cut-street of a workpiece according to an aspect of the present disclosure; and

FIG. 8 shows a simplified flow diagram for another exemplary method according to an aspect of the present disclosure.

### DETAILED DESCRIPTION

The following detailed description refers to the accompanying drawings that show, by way of illustration, specific details, and aspects in which the present disclosure may be practiced. These aspects are described in sufficient detail to enable those skilled in the art to practice the present disclosure. Various aspects are provided for tools and devices, and various aspects are provided for methods. It will be understood that the basic properties of the tool assembly also hold for the methods and vice versa. Other aspects may be utilized and structural, and logical changes may be made without departing from the scope of the present disclosure. The various aspects are not necessarily mutually exclusive, as some aspects can be combined with one or more other aspects to form new aspects.

According to the present disclosure, a present tool assembly, which may be a semiconductor manufacturing tool assembly, may include a cutting component that performs a laser cutting operation that uses a laser beam that is directed by or works with a water jet/stream, e. g, a laser microjet (LMJ) technique, and/or mechanical separation to provide enhanced glass core/substrate dicing processes that may improve yields and quality control. The present tool assembly and method may provide a clean transparent glass core surface without damaging the glass core, which is critical for the dicing/singulation process. Package cores/substrates may have an enormous volume of resin/polymer, i.e., organic build-up (BU) layers having thicknesses up to a few hundred microns, that need to be removed from the cut-streets.

In an aspect, the present tool assembly may have a cutting component that includes a first laser source such as an ultra-violet light laser, a greenlight laser, an infrared laser, and other laser lights, which may have pulse widths that range from nanoseconds to femtoseconds, that may be used to remove the build-up layers while being able to travel through the glass core/substrate leaving it undamaged. In an aspect, it is understood that there are compositions of glass (e.g., borosilicate glass, soda-lime glass, quartz glass, and other photosensitive glass) that will allow light to pass through them without extensive absorption, while the resins/polymers in the BU layers are relatively absorbent to these wavelengths, i.e., a present laser may be selected so that glass used will be transparent to the laser light. This difference in absorption may be used to promote the laser light absorption by the resin/polymer, as well as transmission through the glass, to create a clean ablation of resin/polymer and other materials in the build-up layers on both sides of the glass core, either by processing each side of a semiconductor panel or wafer individually or in a single-sided process that removes both the topside and backside build-up layers. In addition, the present LMJ process inherently cleans the debris and prevents its redeposition in the cut-streets.

In another aspect, after the BU layers are removed, a Bessel beam or filamentation technique using a second laser source may be used to “perforate” (i.e., modify) the glass core along the cut street, and this may be followed by a mechanical breaking/separation technique to complete the dicing/singulation. The second laser source may include, for example, a pulsed green laser, an IR laser, a carbon dioxide (CO2) laser, an ultraviolet (UV) laser, an ultra-short pulse laser, and a diode-pumped solid-state laser.

The present disclosure provides a tool assembly that includes a support for a workpiece (i.e., a partially or fully completed semiconductor panel or wafer), a water delivery component that includes an inlet from a water source and an outlet nozzle that directs water to the workpiece, and a cutting component that includes at least one laser source with optical system, and/or mechanical separator and is configured to operate in a wet environment (i.e., in the presence of water) to remove the build-up (BU) layers and other layers (e.g., insulative layers) from the workpiece, i.e., at the cut-street locations, and in a dry environment to modify or cut through the glass core.

In an aspect, the water delivery component further includes a chamber having an opening for receiving a laser beam, the outlet nozzle being configured to produce a stream of water, and a water return subcomponent. In another aspect, the laser source includes a first laser source configured to provide the laser beam that is directed through the opening of the chamber to the outlet nozzle and travels together with the stream of water to cut through and remove material from first BU layers and second BU layers.

The present disclosure provides a method for dicing a semiconductor panel having a glass core with topside BU layers and backside BU layers. In an aspect of the method, a tool assembly having a water delivery component including an outlet nozzle configured to direct water to a workpiece, a cutting component including a first laser source configured to operate in a wet environment (i.e., in the presence of water) and a second laser source configured to operate in a dry environment. In an aspect of the method, the cut-streets may be formed in the topside and backside BU layers of the workpiece using a first laser beam from the first laser source that is directed by the water from the water delivery component to the workpiece to cut through and remove material from the topside and backside BU layers to expose the glass core. In another aspect of the method, the exposed glass core may be modified, e.g., perforated, along the cut-streets using a second laser beam from the second laser source.

In an aspect, the first laser source may include, for example, an ultra-violet light laser, a greenlight laser, an infrared laser, and other laser lights that remove the build-up layers while being able to travel through the glass core/substrate leaving it undamaged, and the second laser source may include, for example, a pulsed green laser, an IR laser, a CO2 laser, an ultraviolet laser, an ultra-short pulse laser, and diode-pumped solid-state laser.

The present disclosure is also directed to a method for dicing a workpiece with a first topside BU layers having first cut-streets that expose a first surface of the glass core and a second backside BU layers having second cut-streets that expose a second surface of the glass core. In this aspect, the method includes providing a tool assembly having a water delivery component configured to direct water to the workpiece and a cutting component including a laser source with an optical system and a mechanical separator that is configured to operate in a wet environment (i.e., in the presence of water) and forming glass cut-streets in the glass core by directing flowing water from the water delivery component to the workpiece and using the cutting component to remove material and cut through the glass core.

The technical advantages of the present disclosure include, but are not limited to:
(i) providing the benefits of cutting using water including improved cut-edge quality and regulating glass temperature;
(ii) providing removal of debris from the cut-streets and reducing the presence of airborne contaminates; and
(iii) providing specific operations for removing materials from the build-up layers and for separating the glass core in environments that enable improved efficiency and results for the separation of dies in semiconductor panels and/or wafers.

To more readily understand and put into practical effect the present tool assembly, methods, and devices resulting therefrom, which may provide improved manufacturing yields and performance, particular aspects will now be described by way of examples provided in the drawings that are not intended as limitations. The advantages and features of the aspects herein disclosed will be apparent through reference to the following descriptions relating to the accompanying drawings. Furthermore, it is to be understood that the features of the various aspects described herein are not mutually exclusive and can exist in various combinations and permutations. For the sake of brevity, duplicate descriptions of features and properties may be omitted.

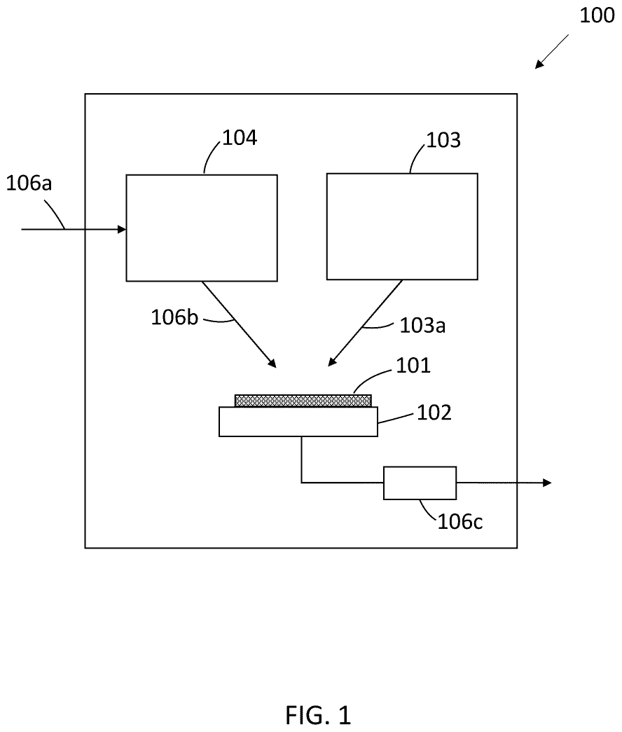

FIG. 1 shows exemplary representations of a tool assembly 100 according to an aspect of the present disclosure. In this aspect, the tool assembly 100 includes a support 102 for a workpiece 101 (e.g., a completed or partially completed semiconductor panel or wafer), a cutting component, which may include a laser source 103, and a water delivery component 104. It should be understood that the present tool assembly may include additional components that are not shown and that such components may include one or more subcomponents or modules. In addition, the use of the elements/features within a component or subcomponent may be activated on an as needed basis to perform a specific operation.

In an aspect, the laser source 103 may include one or more lasers that may have different laser generators/sources that generate a laser beam 103a of different wavelengths, i.e., one for ablating resin/polymer material and another for perforating/modifying or ablating glass material, as well as various optical system/components, such as lenses, collimators, filters, etc. The tool assembly 100 may include a controller (not shown) that enables, for example, switching between a first laser and a second laser as needed for the present methods of operation, including operating in a wet environment or a dry environment when dicing the workpiece 101. It should be understood that the present tool assembly may have a first module with the first laser for polymer ablation and a second module with the second laser for modifying the glass core (such modules are not shown) .

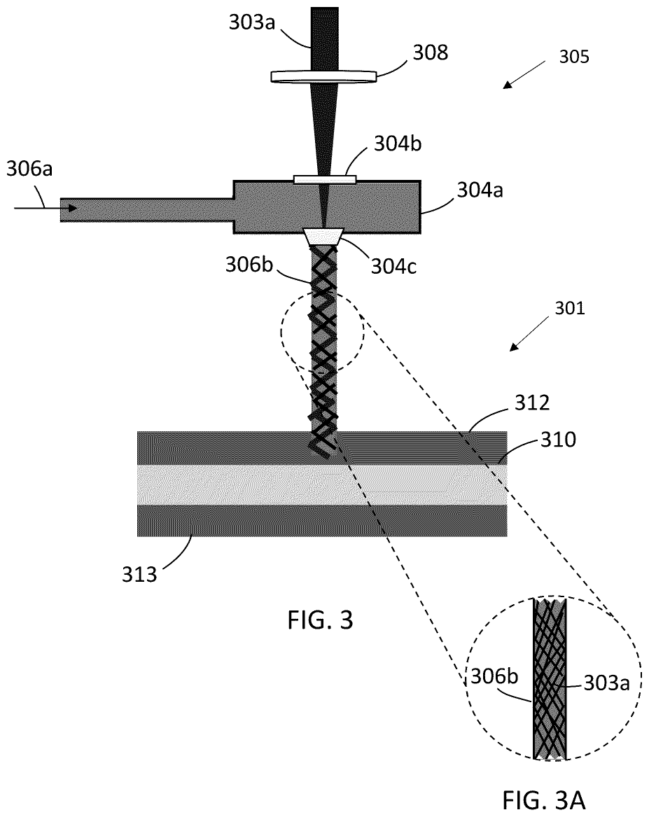

In an aspect, the water delivery component 104 may include an inlet 106a from a water source, a water outlet 106b (e.g., a nozzle or sprayer) that directs the water (e.g., as a water jet) to the workpiece 101, and a water removal/return subcomponent 106c (e.g., a blower, air knife, a fan, and/or a pump/suction unit and conduits/couplings therefore) that removes the water from the workpiece or re-circulates the water for reuse may be coupled to the support 102. In addition, the support 102 may be configured to permit the workpiece 101 to be immersed in water during singulation (not shown). In another aspect, the water outlet 106b may be used to direct the laser beam 103a to the workpiece 101 as discussed below in FIG. 3. It should be understood that the water delivery component 104 may also include one or more pumps, a plurality of valves, gauges and conduits that are not shown.

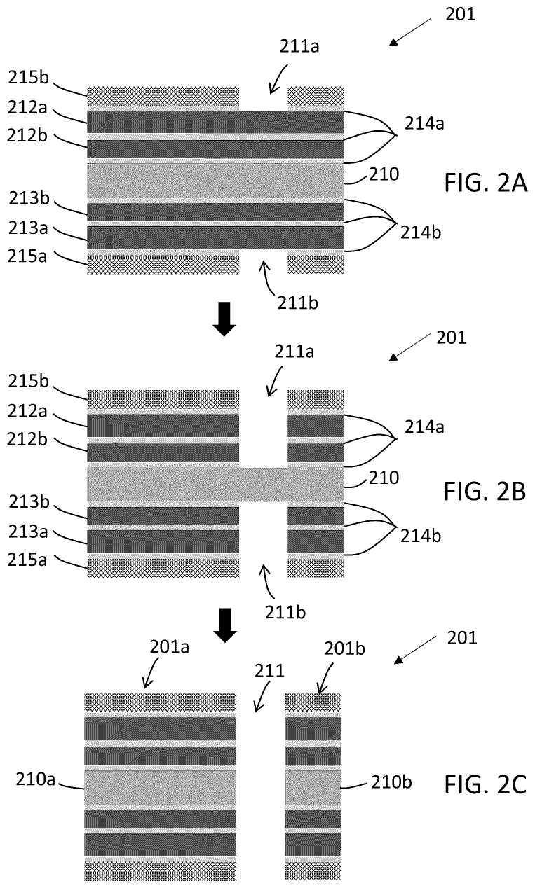

FIGS. 2A through 2C show exemplary representations of a workpiece, which is a semiconductor panel 201, at various stages of processing according to aspects of the present disclosure. In FIG. 2A, the semiconductor panel 201 includes a glass core 210 having topside build-up layers 212a and 212b on a top surface of the semiconductor panel 201 and backside build-up layers 213a and 213b on a backside surface of the semiconductor panel 201. The build-up layers may include a plurality of wiring layers made of metal lines, a.k.a., build-up wiring, that are typically separated by a compound material of glass filler and resin/polymer. A topside resist layer 215a may be disposed over the topside build-up layers 212a and a backside resist layer 215b may be disposed over the backside build-up layers 213a. It should be understood that the number of build-up layers and other layers deposited on a glass core may vary depending on a semiconductor layout design.

In an aspect, a plurality of topside insulating layers 214a (e.g., silicon nitride) may be disposed between the topside resist layer 215a, the topside build-up layers 212a, the topside build-up layers 212b and the glass core 210, and similarly, a plurality of backside insulating layers 214b (e.g., silicon nitride) may be disposed between the backside resist layer 215b, the backside build-up layers 213a, the backside build-up layers 213b and the glass core 210.

In an aspect, the topside resist layer 215a may have a topside opening 211a and the backside resist layer 215b may have a backside opening 211b, which are positioned at a location for a cut-street to be used for dicing/singulation of the semiconductor panel 201. It should be understood that the semiconductor panel 201 may have a plurality of cut-streets that will need to be formed for a dicing/singulation process.

In FIG. 2B, the depth of the topside opening 211a may be further increased by a first laser step that may be used to remove the topside build-up layers 212a and 212b, as well as removing the topside insulating layers 214a and expose the glass core 210. The backside build-up layers 213b and 213a may be removed by either continuing the first laser step or by turning over the semiconductor panel 201 and performing a second laser step. The first and second laser steps may be performed by a water-assisted laser operation or LMJ as discussed in FIG. 3.

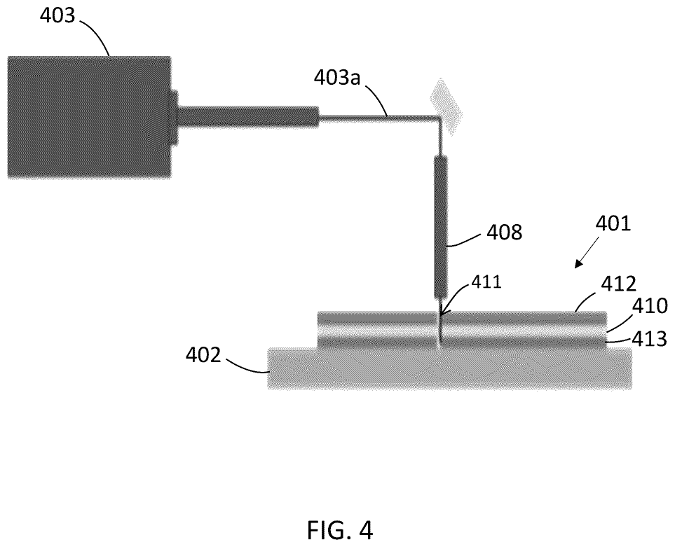

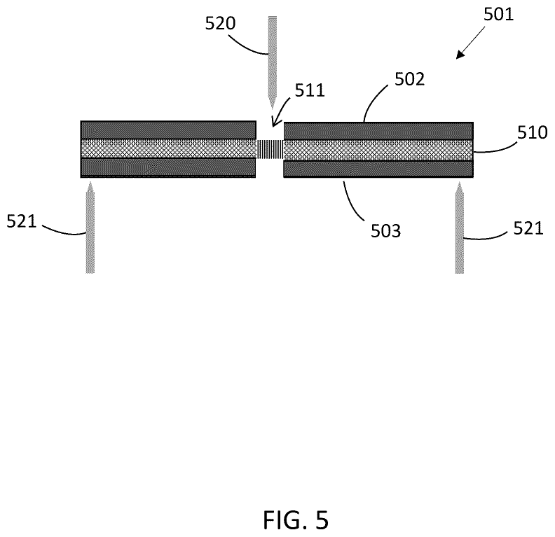

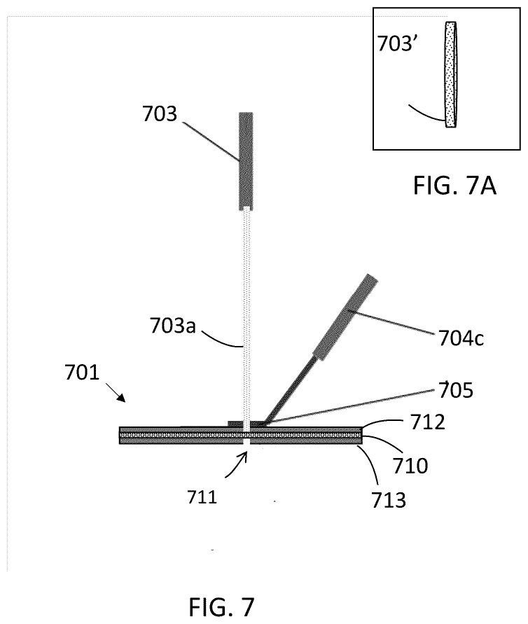

In FIG. 2C, the dicing/singulation of the semiconductor panel 201 may be completed by either: i) laser perforation and mechanical breaking/separation steps, as discussed below in FIG. 4 and FIG. 5: or ii) a laser ablation step, as discussed below in FIG. 7, which will remove glass material to complete a cut-street 211 to form separated glass cores 210a and 210b that are part of singulated dies 201a and 201b.

In an aspect, build-up layers may have a thickness of greater than 100 μm and may typically have a thickness in the range of approximately 100 μm to 3 mm. In another aspect, a glass core may typically have a thickness in the range of approximately 200 to 1100 μm.

FIGS. 3 and 3A show exemplary representations of a laser beam directed by a water jet according to an aspect of the present disclosure. In this aspect, a workpiece 301 with topside and backside build-up layers 312 and 313, respectively, on a glass core 310 may undergo a laser ablation step using a laser microjet (LMJ) 305, which may be a “hybrid” water delivery component of a present tool assembly. The laser microjet 305 is a water-jet-guided laser that provides a pulsed laser beam 303a that is coupled with a low-pressure water jet 306b that guides the laser beam 303a, much like an optical fiber, through a total internal reflection of the laser beam 303a, as shown in FIG. 3A.

In an aspect, the laser beam 303a may be focused by an optical lens 308 and passed through a window 304b into a chamber 304a, which is filled with inlet water 306a from a water source (not shown). The water jet 306b may be produced by a nozzle 304c in the chamber 304a. A suitable laser source may be a UV-light laser, a greenlight laser, an infrared (IR) laser, and other laser lights that may be used to remove build-up layers and provide a laser beam that can travel through a glass core/substrate leaving it undamaged. In an aspect, the backside build-up layers 313 may be removed by either continuing a first LMJ step or by turning over the semiconductor panel 301 and performing a second LMJ step.

In an aspect, the use of LMJ may offer the advantages of having the water remove debris from the build-up layers 312 and cool the build-up layers 312 and glass core 310, which reduces stress-induced damage. Additional advantages over traditional “dry” laser cutting are high dicing speeds, a parallel kerf, and omnidirectional cutting.

FIG. 4 shows an exemplary representation of a laser source 403, which may be a second laser source, being used to generate a laser beam 403a in a second laser operation in a dry environment, after the removal of polymer material from build-up layers 412 and 413 from a workpiece 401, for dicing/singulation according to an aspect of the present disclosure. In this aspect, the laser beam 403a may be passed through an optical “tuner” 408 and directed to a glass core 410 in a partial cut-street 411 of the workpiece 401 that is positioned on a support 402.

In an aspect, the optical tuner 408 may be a solid medium used to manipulate the laser beam 403a by, for example, filamentation (i.e., using a Kerr effect) to attain a self-focused beam to “modify” the glass core 410. According to the present disclosure, to modify a glass core may include the perforating, the creating channels, and the changing the structure of the glass core, which may include the breaking of bonds, the migrating of atoms/ions away from the treated zones, etc. In another aspect, the optical tuner 408 may include an axicon lens with axisymmetric diffraction grating to generate a Bessel beam having a very high aspect ratio, which may cause the exposed section of the glass core 410 to become more brittle. It should be understood that it is within the scope of the present disclosure to generate a Bessel beam with other lens configurations, for example, a diffractive ring lens, axisymmetric diffraction gratings, etc. In both examples, the aspect ratio of the laser beams may be controlled to ensure the whole thickness of the glass core 410 may be modified in a single shot, and this laser operation may be repeated for the lengths of the plurality of saw-streets making the dies easier to separate in a subsequent process step.

FIG. 5 shows an exemplary representation of a workpiece 501 being diced along cut-streets 511 using the present tool assembly according to an aspect of the present disclosure. In this aspect, the workpiece 501 may be modified by a laser using a filamentation or Bessel beam process or other similar process along the cut streets 511 section of a glass core 510. The modified section of the glass core 510 along the cut street 511 may be rendered brittle and may require little force to separate workpieces into dies. For example, the separation may be performed by a mechanical separator such as a mechanical cleaver 520 and/or bending pins 521, which may be used individually or together as a unit. Other methods such as an additional laser separation process, breaking by pulling, and other mechanical separation methods may also be used. This additional laser separation may be performed by a third laser source, which may include, for example, a continuous wave laser, a solid-state laser, a gas laser, etc., that included as part of a cutting component of a present tool assembly.

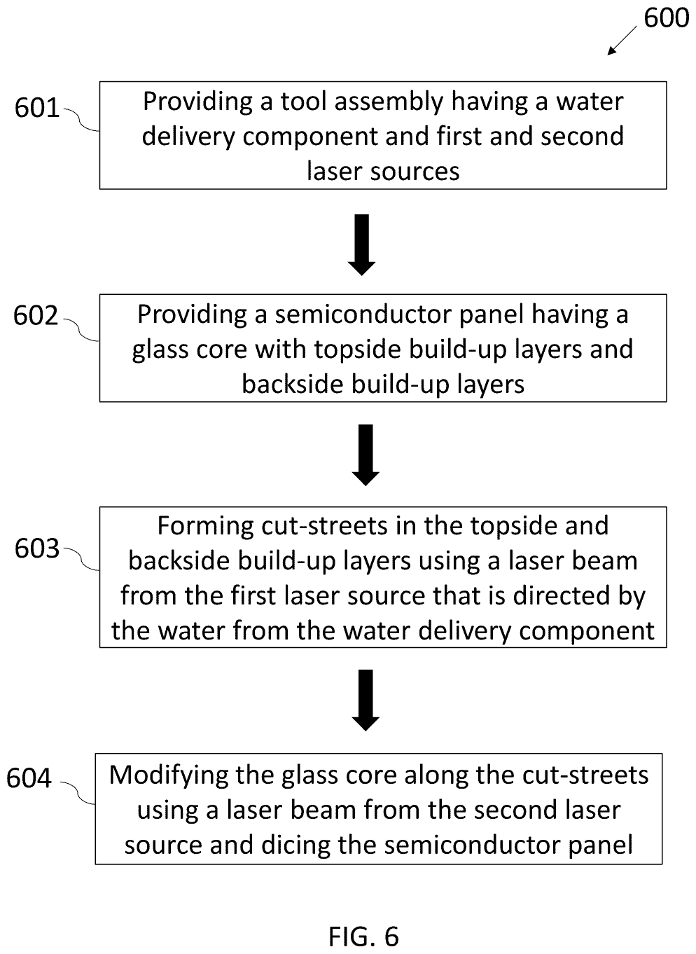

FIG. 6 shows a simplified flow diagram to outline an exemplary method according to an aspect of the present disclosure.

The operation 601 may be directed to providing a tool assembly having a water delivery component and first and second laser sources. The tool assembly is used to process semiconductor panels.

The operation 602 may be directed to providing a semiconductor panel having a glass core with topside build-up layers and backside build-up layers.

The operation 603 may be directed to forming cut-streets in the topside and backside build-up layers using a laser beam from the first laser source that is directed by the water from the water delivery component. This operation will remove the resin/polymer from the cut-streets without damaging the glass core.

The operation 604 may be directed to modifying the glass core along the cut-streets (e.g., perforating) using a laser beam from the second laser source and dicing the semiconductor panel thereafter (e.g., using a mechanical separator/cutting tool).

FIG. 7 shows an exemplary representation of a laser beam 703a provided by a laser 703 and flowing water 705 being directed by a nozzle 704c of a water delivery component of a tool assembly (not shown) according to an aspect of the present disclosure. In this aspect, a cut-street 711 may be pre-formed in a workpiece 701 by the present water-assisted laser method or a conventional etching method to remove material from topside and backside build-up layers 712 and 713, respectively. The laser beam 703a may ablate an exposed section of the glass core 710 in the presence of the water 705, which may form a flowing water film over the workpiece 701. In another aspect, in FIG. 7A, a mechanical separator/saw 703′may also be used in place of a laser 703 to complete the cut-street 711 to dice the workpiece 701.

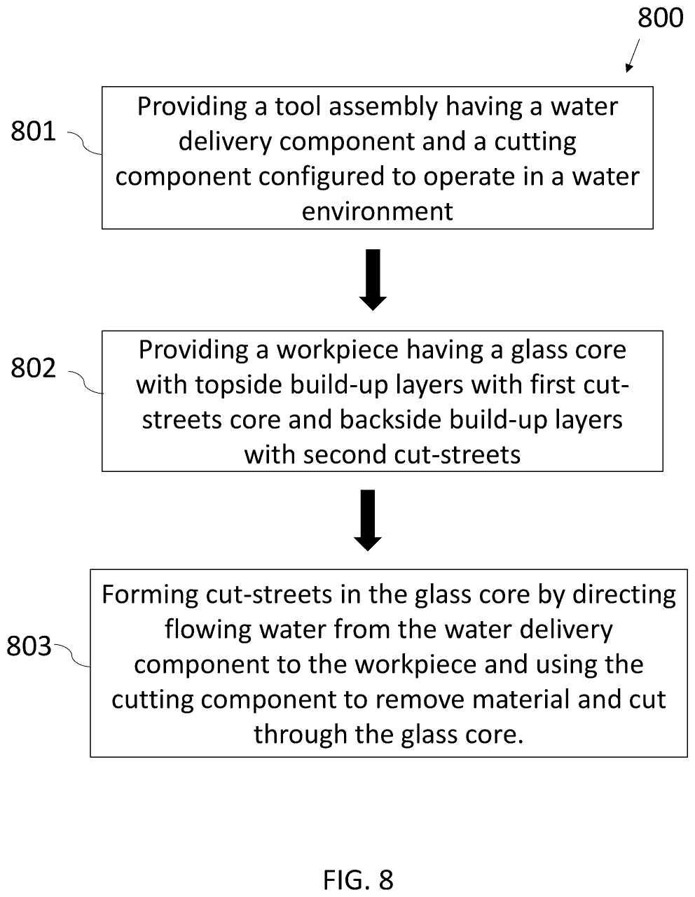

FIG. 8 shows a simplified flow diagram to outline another exemplary method according to another aspect of the present disclosure.

The operation 801 may be directed to providing a tool assembly having a water delivery component and a cutting component configured to operate in a wet environment (i.e., in the presence of water). The tool assembly is used to process semiconductor panels.

The operation 802 may be directed to providing a workpiece having a glass core with topside build-up layers with first cut-streets and backside build-up layers with second cut-streets. The first and second cut-streets may be pre-formed on the tool assembly using a water-directed laser, i.e., LMJ, as an earlier operation or using a separate tool assembly that uses other conventional etching techniques.

The operation 803 may be directed to forming cut-streets in the glass core by directing flowing water from the water delivery component to the workpiece and using the cutting component to remove material and cut through the glass core.

It will be understood that any property described herein for a particular method for dicing and singulation using laser cutting for a semiconductor panel may also hold for any semiconductor wafer using the present methods described herein. It will also be understood that any property described herein for a specific method may hold for any of the methods described herein. Furthermore, it will be understood that for the methods described herein, not necessarily all the operations described will be shown in the accompanying drawings or method, but only some (not all) components or operations may be disclosed.

To more readily understand and put into practical effect the laser cutting of semiconductor panels and wafers using a tool assembly and methods providing a wet cutting environment and a dry cutting environment, they will now be described by way of examples. For the sake of brevity, duplicate descriptions of features and properties may be omitted.

### EXAMPLES

Example 1 provides an apparatus/tool assembly including a support for a workpiece, a water delivery component having an inlet from a water source and an outlet nozzle that directs water to the workpiece, and a cutting component having a laser source with an optical system and a mechanical separator. In an aspect, the cutting component is configured to operate in a wet environment and a dry environment to remove material from the workpiece, for which cut-streets are formed by removing the material.

Example 2 may include the apparatus of example 1 and/or any other example disclosed herein, for which the workpiece includes a glass core having a first surface and a second surface, and first build-up (BU) layers disposed on the first surface of the glass core and second BU layers disposed on the second surface of the glass core.

Example 3 may include the apparatus of example 2 and/or any other example disclosed herein, for which the water delivery component further includes a chamber having an opening for receiving a laser beam, the outlet nozzle for producing a stream of water, and a water return subcomponent.

Example 4 may include the apparatus of example 3 and/or any other example disclosed herein, for which the laser source includes a first laser configured to provide the laser beam that is directed through the opening to the outlet nozzle and travels together with the stream of water to cut through and remove material from the first BU layers and the second BU layers.

Example 5 may include the apparatus of example 4 and/or any other example disclosed herein, for which the first laser includes a UV-light laser, a greenlight laser, an IR laser, and other laser that provide the laser beam that glass transparent and travels through the glass core.

Example 6 may include the apparatus of example 4 and/or any other example disclosed herein, for which the laser source further includes a second laser configured to operate in the dry environment to modify the glass core along the cut-streets.

Example 7 may include the apparatus of example 6 and/or any other example disclosed herein, for which the mechanical separator further includes a mechanical cleaver or bending pins to separate the glass core at the cut-streets.

Example 8 may include the apparatus of example 4 and/or any other example disclosed herein, for which the laser source further includes a second laser configured to operate in the dry environment to cut through and remove material from the glass core along the cut-streets.

Example 9 may include the apparatus of example 10 and/or any other example disclosed herein, for which the workpiece includes a glass core having a first surface and a second surface, and a first BU layers with first cut-streets disposed on the first surface of the glass core, for which the first cut-streets expose the first surface of the glass core, and a second BU layers with second cut-streets disposed on the second surface of the glass core, for which the second cut-streets expose the second surface of the glass core.

Example 10 may include the apparatus of example 9 and/or any other example disclosed herein, for which the outlet nozzle of the water delivery component provides a flowing film of water on the workpiece.

Example 11 may include the apparatus of example 10 and/or any other example disclosed herein, for which the mechanical separator includes a mechanical saw configured to remove material from and cut through the glass core with the flowing film of the water.

Example 12 may include the apparatus of example 10 and/or any other example disclosed herein, for which the laser source includes a laser configured to direct a laser beam that removes material and cuts through the glass core with the flowing film of the water.

Example 13 may include the apparatus of example 10 and/or any other example disclosed herein, for which the support is configured to immerse the workpiece in water during the removal of material from the glass core of the workpiece.

Example 14 provides a method that includes using a apparatus for singulating a workpiece. The semiconductor assembly having a water delivery component including an inlet from a water source and an outlet nozzle that directs water to a workpiece, and a cutting component including a first laser source configured to operate in a wet environment and a second laser source configured to operate in a dry environment, providing the workpiece that includes a glass core having a topside surface and topside BU layers disposed thereon and a backside surface with backside BU layers disposed thereon, forming cut-streets in the topside and backside BU layers of the workpiece using a first laser beam from the first laser source that is directed by the water from the water delivery component to the workpiece to cut through and remove material from the topside and backside BU layers to expose the glass core, and modifying the glass core along the cut-streets using a second laser beam from the second laser source.

Example 15 may include the method of example 14 and/or any other example disclosed herein, for which the modifying the glass core along the cut-street using the second laser beam further includes perforating, creating channels, breaking bonds, and/or changing structures within the glass core.

Example 16 may include the method of example 14 and/or any other example disclosed herein, further includes dicing the workpiece along the cut-streets using a mechanical separator or a third laser beam from a third laser source.

Example 17 provides a method that includes providing a apparatus for singulating a workpiece, for which the apparatus includes a water delivery component having an outlet nozzle configured to direct water to the workpiece and a cutting component including a laser source and optical system or mechanical separator that is configured to operate in a wet environment, providing the workpiece that includes a glass core having a first surface and a second surface, and first BU layers with first cut-streets disposed on the first surface of the glass core, for which the first cut-streets expose the first surface of the glass core, and second BU layers with second cut-streets disposed on the second surface of the glass core, for which the second cut-streets expose the second surface of the glass core, and forming glass cut-streets in the glass core by directing flowing water from the water delivery component to the workpiece and using the cutting component to remove material and cut through the glass core.

Example 18 may include the method of example 17 and/or any other example disclosed herein, further including using the laser source to remove material from and cut through the glass core as the flowing water is directed to the workpiece.

Example 19 may include the method of example 17 and/or any other example disclosed herein, further including using the mechanical separator to remove material from and cut through the glass core as the flowing water is directed to the workpiece.

Example 20 may include the method of example 17 and/or any other example disclosed herein, further includes immersing the workpiece with the flowing water while the cutting component is removing material and cutting through the glass core.

The term “comprising” shall be understood to have a broad meaning similar to the term “including” and will be understood to imply the inclusion of a stated integer or operation or group of integers or operations but not the exclusion of any other integer or operation or group of integers or operations. This definition also applies to variations on the term “comprising” such as “comprise”and “comprises”.

The term “coupled” (or “connected”) herein may be understood as electrically coupled or as mechanically coupled, e.g., attached or fixed or attached, or just in contact without any fixation, and it will be understood that both direct coupling or indirect coupling (in other words: coupling without direct contact) may be provided.

The terms “and” and “or” herein may be understood to mean “and/or” as including either or both of two stated possibilities.

While the present disclosure has been particularly shown and described with reference to specific aspects, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced.

What is claimed is:

1. An apparatus comprising:
a support for a workpiece;
a water delivery component, wherein the water delivery component comprises an inlet from a water source and an outlet nozzle that directs water to the workpiece; and
a cutting component, wherein the cutting component comprises a laser source with an optical system, and a mechanical separator and is configured to operate in a wet environment and a dry environment to remove material from the workpiece.

2. The apparatus of claim 1, wherein the workpiece comprises:
a glass core having a first surface and a second surface; and
first build-up (BU) layers disposed on the first surface of the glass core and second BU layers disposed on the second surface of the glass core.

3. The apparatus of claim 2, wherein the water delivery component further comprises a chamber having an opening for receiving a laser beam, the outlet nozzle for producing a stream of water, and a water return subcomponent.

4. The apparatus of claim 3, wherein the laser source comprises a first laser configured to provide the laser beam that is directed through the opening to the outlet nozzle and travels together with the stream of water to cut through and remove material from the first BU layers and the second BU layers.

5. The apparatus of claim 4, wherein the first laser comprises a UV-light laser, a greenlight laser, an IR laser, and other laser that provide the laser beam that glass transparent and travels through the glass core.

6. The apparatus of claim 4, wherein the laser source further comprises a second laser configured to operate in the dry environment to modify the glass core along the cut-streets.

7. The apparatus of claim 6, wherein the mechanical separator further comprises a mechanical cleaver or bending pins to separate the glass core at the cut-streets.

8. The apparatus of claim 4, wherein the laser source further comprises a second laser configured to operate in the dry environment to cut through and remove material from the glass core along the cut-streets.

9. The apparatus of claim 1, wherein the workpiece comprises:
a glass core having a first surface and a second surface; and
a first BU layers with first cut-streets disposed on the first surface of the glass core, wherein the first cut-streets expose the first surface of the glass core; and
a second BU layers with second cut-streets disposed on the second surface of the glass core, wherein the second cut-streets expose the second surface of the glass core.

10. The apparatus of claim 9, wherein the outlet nozzle of the water delivery component provides a flowing film of water on the workpiece.

11. The apparatus of claim 10, wherein the mechanical separator comprises a mechanical saw configured to remove material from and cut through the glass core with the flowing film of the water.

12. The apparatus of claim 10, wherein the laser source comprises a laser configured to direct a laser beam that removes material and cuts through the glass core with the flowing film of the water.

13. The apparatus of claim 10, wherein the support is configured to immerse the workpiece in water during the removal of material from the glass core of the workpiece.

14. A method comprising:
providing an apparatus for singulating a workpiece, wherein the apparatus comprises:
a water delivery component comprising an inlet from a water source and an outlet nozzle that directs water to the workpiece; and
a cutting component comprising a first laser source configured to operate in a wet environment and a second laser source configured to operate in a dry environment;
providing the workpiece, wherein the workpiece comprises:
a glass core having a topside surface with topside BU layers disposed thereon and a backside surface with backside BU layers disposed thereon,
forming cut-streets in the topside and backside BU layers of the workpiece using a first laser beam from the first laser source that is directed by the water from the water delivery component to the workpiece to cut through and remove material from the topside and backside BU layers to expose the glass core; and
modifying the glass core along the cut-streets using a second laser beam from the second laser source.

15. The method of claim 14, wherein the modifying the glass core along the cut-street using the second laser beam further comprises perforating, creating channels, breaking bonds, and/or changing structures within the glass core.

16. The method of claim 14, further comprises dicing the workpiece along the cut-streets using a mechanical separator or a third laser beam from a third laser source.

17. A method comprising:
providing an apparatus for singulating a workpiece, wherein the apparatus comprises:
a water delivery component comprising an outlet nozzle configured to direct water to the workpiece; and
a cutting component comprising a laser source and optical system or mechanical separator that is configured to operate in a wet environment;
providing the workpiece, wherein the workpiece comprises:
a glass core having a first surface and a second surface; and
first BU layers with first cut-streets disposed on the first surface of the glass core, wherein the first cut-streets expose the first surface of the glass core; and
second BU layers with second cut-streets disposed on the second surface of the glass core, wherein the second cut-streets expose the second surface of the glass core; and
forming glass cut-streets in the glass core by directing flowing water from the water delivery component to the workpiece and using the cutting component to remove material and cut through the glass core.

18. The method of claim 17, further comprising using the laser source to remove material from and cut through the glass core as the flowing water is directed to the workpiece.

19. The method of claim 17, further comprising using the mechanical separator to remove material from and cut through the glass core as the flowing water is directed to the workpiece.

20. The method of claim 17, further comprises immersing the workpiece with the flowing water while the cutting component is removing material and cutting through the glass core.
